(19) United States
(12) Patent Application Publication
(10) Pub. No.: US 2014/0306725 A1
(43) Pub. Date: Oct. 16, 2014

(54) System for Wireless Corrosion Monitoring

(71) Applicant: William N. Carr, Montclair, NJ (US)

(72) Inventor: William N. Carr, Montclair, NJ (US)

(21) Appl. No.: 13/863,117

(22) Filed: Apr. 15, 2013

(51) Int. Cl. G01N 17/04

(52) U.S. Cl. CPC G01N 17/04
USPC 324/700

(57) ABSTRACT

A system is disclosed for wireless monitoring of corrosion as it occurs in a corrodible object. The system comprises one or more wireless corrosion sensors. A wireless corrosion sensor comprises an antenna assembly for transmitting and receiving radio signals. In the antenna assembly, at least part of the antenna assembly is made out of a corrodible material, such that, as the corrodible material undergoes corrosion, radio signals that are transmitted or received are affected. A remote system can estimate the extent of corrosion that has occurred by monitoring radio signals that are transmitted through the antenna assembly as it undergoes corrosion.

### FIELD OF THE INVENTION

The present invention relates to wireless sensors in general, and, more particularly, to wireless sensors for corrosion monitoring.

### BACKGROUND OF THE INVENTION

Wireless sensors for a sensing a variety of physical quantities have been in use for a long time in a variety of applications. As the cost of radio systems continues to decline, more applications of wireless sensing become feasible.

Corrosion is a significant source of impairment in a variety of situations. For example, bridges, buildings and other outdoor structures that are exposed to the elements are subject to corrosion that might impair their functionality and, in extreme cases, might lead to catastrophic failure. Therefore, it is important to monitor the extent of corrosion in these and other structures and systems where corrosion occurs.

A part of a structure or system that is subject to being corroded (hereinafter “corrodible”) might not be readily accessible for direct inspection or testing. For example, a part of a bridge or building that is high above ground is likely to be difficult to access. In other cases, a corrodible element might be encased in something and difficult to access. This is so, for example, for the reinforcing steel bars that are encased inside reinforced concrete. In such cases, it is advantageous to have an in situ wireless sensor that monitors corrosion and transmits a wireless signal with information about the extent of corrosion to a wireless receiver located in a more accessible place.

Wireless corrosion sensors are well known in the art. Generally, they comprise a so-called “coupon” that undergoes corrosion in a predictable manner when exposed to causes of corrosion. The coupon is installed near the corrodible object to be monitored such that the coupon is exposed to the same causes of corrosion as the object to be monitored. Wireless sensors typically have electronic circuitry to measure some physical characteristic of the coupon known to be affected by the extent of corrosion of the coupon. For example, a wireless sensor might measure the electrical resistance of the coupon. The result of a measurement is then transmitted, via a radio signal, to a suitable wireless receiver.

Hereinafter, words such as “conductor”, “conductive”, “conductivity”, “resistance”, “resistive”, “resistivity”, “insulator”, “insulating” etc., refer to electrical properties, unless explicitly indicated otherwise. Also, words such as “connect”, “interconnect”, “coupled”, and their related and inflected forms, refer to electrical connections, interconnections, or coupling, unless explicitly indicated otherwise.

Wireless corrosion sensors are effective, but costly. The need to have circuitry to measure a physical characteristic of the coupon adds to their cost. The need to have circuitry to encode the measurement results into a radio signal also adds to their cost. And both needs lead to increased power consumption that is difficult to satisfy with batteries.

FIG. 1 depicts corrosion monitoring technique 100 in accordance with the prior art. Corrodible object 110 is a corrodible object for which it is desired to monitor the extent of corrosion that might be occurring. Therefore, coupon 120 is affixed to corrodible object 110. Coupon 120 is made of a material that undergoes corrosion in a manner that closely follows the corrosion of corrodible object 110. At regular intervals, coupon 120 is physically removed from object 110 and is brought to a laboratory where the extent of corrosion of coupon 120 is accurately measured. The result of the measurement can be used to estimate the extent of corrosion of corrodible object 110. After each laboratory measurement, coupon 120 is again affixed to corrodible object 110. Alternatively, after a laboratory measurement, a new coupon might be affixed to corrodible object 110.

FIG. 2 depicts wireless corrosion monitoring technique 200 in accordance with the prior art. Corrodible object 110 is the same corrodible object as in FIG. 1, and it is desired to monitor the extent of corrosion of corrodible object 110 that might be occurring. For that purpose, wireless corrosion sensor 230 is affixed to corrodible object 110.

Wireless corrosion sensor 230 comprises coupon 220, electronic circuit 240, and radio transmitter 250, interrelated as shown. Similar to coupon 120 in FIG. 1, coupon 220 is also made of a material that undergoes corrosion in a manner that closely follows the corrosion of corrodible object 110. However, in this case, the material is chosen such that its electrical resistance changes by a measurable amount in response to corrosion.

Electronic circuit 240 is adapted to measure the resistance of coupon 220. Electronic circuit 240 transmits the results of such resistance measurements to radio transmitter 250 through electrical connection 260. Radio transmitter 250 encodes the measurement results into a radio signal and transmits that signal.

Wireless corrosion sensor 230 might use well-known RFID technology for implementing radio transmitter 250. For example, wireless corrosion sensor 230 might use passive RFID technology, or semi-passive RFID technology, or active RFID technology.

FIG. 3 depicts monopole antenna 300, which is a type of antenna commonly used in the prior art. For example, it might be used by radio transmitter 250 for transmitting the radio signal. Monopole antenna 300 comprises monopole 310, ground plane 320 and transmission line 330, interrelated as shown. In particular, when antenna 300 is used as a transmitting antenna, transmission line 330 carries the radio signal to be transmitted.

As is well known in the art, monopole antenna 300 provides good performance when used to transmit radio signals within a certain range of frequencies, and provides optimal performance for a particular frequency that is referred to as “center frequency” because it is near the center of the range. The center frequency of a monopole antenna is related to the physical size of the monopole; in particular, it is related to the length of the monopole through a well-known mathematical relationship. More generally, most antennas of most types are characterized by a “center frequency” whose value is related to their physical size.

### SUMMARY OF THE INVENTION

Embodiments of the present invention provide a wireless corrosion sensor that does not require a coupon, and, therefore does not require an electrical circuit to measure a physical characteristic of the coupon. In embodiments of the present invention, the wireless corrosion sensor has an antenna for achieving wireless communication. The functionality of a coupon is performed, for example, by a portion of the antenna that is made of a corrodible material. The corrodible material in the antenna is chosen such that it undergoes corrosion in a manner that closely follows the corrosion of the object whose corrosion is to be monitored.

As the corrodible portion of the antenna becomes corroded, some radio-frequency characteristics of the antenna change. For example, the physical size of the antenna might change because of corrosion and, as a result, its center frequency might change. Alternatively, the resistance of the corrodible portion of the antenna might change and, as a result, the impedance of the antenna might change, or the attenuation caused by the antenna to a radio signal might change.

Changes in radio-frequency characteristics of the antenna affect radio signals that pass through the antenna. For example, a radio signal that is transmitted by the wireless corrosion sensor is affected. As a result, a receiver that receives the radio signal is able to detect that the antenna has become corroded simply by monitoring the radio signal without the need for the wireless corrosion sensor to perform measurements.

Embodiments of the present invention might comprise wireless corrosion sensors with the functionality of a passive RFID tag, or of a semi-passive RFID tag, or of an active RFID tags. Such sensors might be realized as radio transceivers that receive a radio signal and transmit a radio signal, with one or both of such radio signals passing through the antenna with the corrodible material.

Alternative embodiments of the present invention also comprise a reference radio transceiver, i.e., a device that is similar, in most respects, to the wireless corrosion sensor, except for lacking the corrodible material in the antenna: the reference transceiver has an antenna without corrodible material. Therefore, radio signals that pass through the reference transceiver are not affected by corrosion. A receiver that monitors radio signals from wireless corrosion sensors can achieve improved accuracy by comparing those radio signals to the radio signal transmitted by the reference transceiver.

Because the wireless corrosion sensor does not need to make any measurements, its radio circuitry can be very simple. For example, it might be a simple backscatter radio circuit. Backscatter radio techniques are well known in the art. A simple implementation of backscatter radio is based on a radio circuit that consists of just one device with the property of non-linearity, such as a semiconductor diode.

Alternative embodiments of the present invention use a different, novel, device with the property of non-linearity: When two dissimilar metals are in contact with one another, they are said to form a “bimetallic junction”. Such a junction is subject to corrosion. A consequence of corrosion in a bimetallic junction is, frequently, that the junction develops a non-linearity. The extent of the non-linearity depends on the extent of corrosion.

Alternative embodiments of the present invention use a bimetallic junction in their radio circuitry. In such embodiments, the antenna does not need to have a corrodible portion. As corrosion occurs in the bimetallic junction, the non-linearity of the bimetallic junction changes and the extent of corrosion can be estimated by monitoring a radio signal backscattered by the bimetallic junction.

### BRIEF DESCRIPTION OF THE DRAWINGS

FIG. 1 depicts a corrosion monitoring technique in the prior art.

FIG. 2 depicts a wireless corrosion monitoring technique in the prior art.

FIG. 3 depicts a monopole antenna in the prior art.

FIG. 4 depicts a capacitive corrosion sensor.

FIG. 5 depicts a corrodible monopole antenna in accordance with a first illustrative embodiment of the present invention.

FIG. 6 depicts a single-cavity corrodible antenna in accordance with a second illustrative embodiment of the present invention.

FIG. 7 depicts a dual-cavity corrodible antenna in accordance with a third illustrative embodiment of the present invention.

FIG. 8 depicts a corrodible dipole antenna in accordance with a fourth illustrative embodiment of the present invention.

FIG. 9 depicts a corrodible patch antenna in accordance with a fifth illustrative embodiment of the present invention.

FIG. 10 depicts a wireless corrosion sensor with bimetallic junction in accordance with a sixth illustrative embodiment of the present invention.

FIG. 11 shows a block diagram of a wireless corrosion sensor in accordance with some embodiments of the present invention.

FIG. 12 shows a block diagram of a system for estimating corrosion in accordance with some embodiments of the present invention.

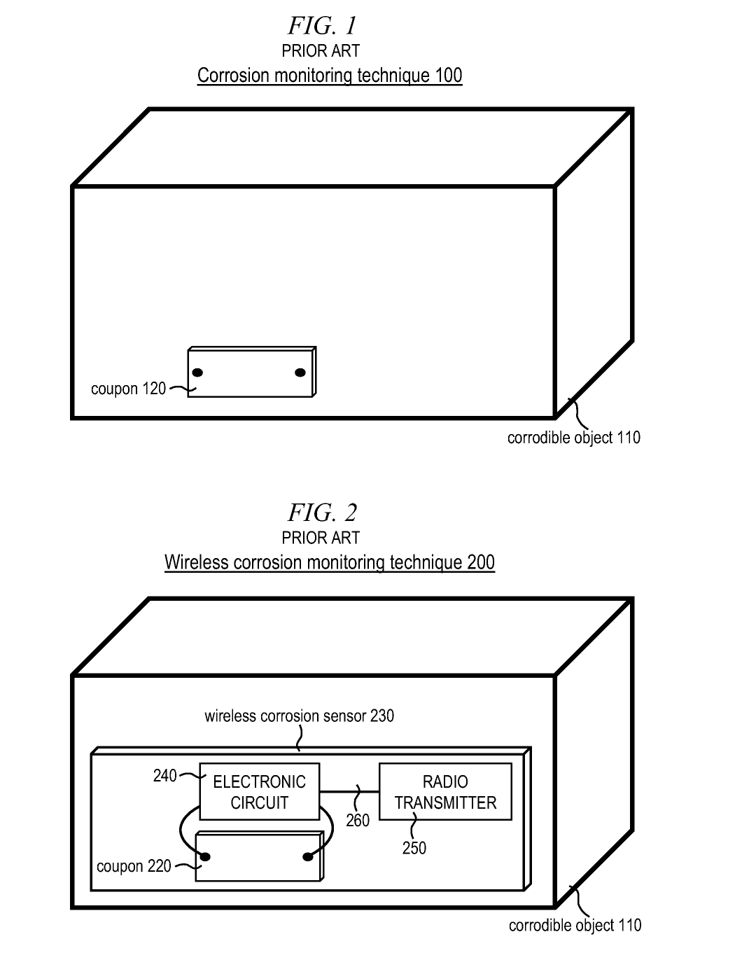

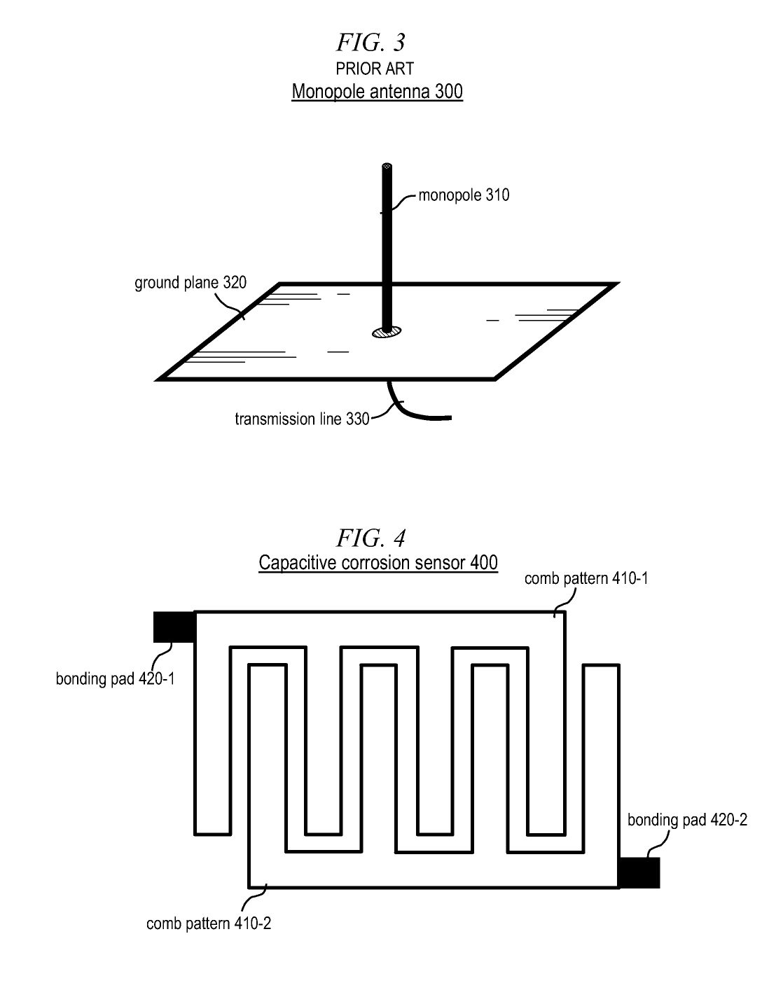

### DETAILED DESCRIPTION

FIG. 4 depicts capacitive corrosion sensor 400, which comprises: comb patterns 410-1 and 410-2, bonding pads 420-1 and 420-2, interrelated as shown. In particular, comb patterns 410-1 and 410-2 are placed next to one another in accordance with a disposition known in the art as “interdigitated”.

Comb patterns 410-1 and 410-2 are patterns of corrodible conductive material deposited as a thin film on a dielectric substrate. Bonding pads 420-1 and 420-2 are conductive pads for enabling capacitive corrosion sensor 400 to be connected to an electrical circuit. The use of the word “comb” in comb patterns 410-1 and 410-2 derives from the fact that their shape resembles a comb in that each has a set of protruding parallel strips, similar to the teeth of a comb, that are connected to one another at one end by another strip, similar to the shaft of the comb. The word “interdigitated” refers to the fact that the teeth of one comb pattern are interleaved with the teeth of the other comb pattern like the fingers of folded hands.

The two interdigitated patterns together form a capacitor because of the proximity of the conductive material in one pattern to the conductive material in the other pattern. The electric circuit connected to capacitive corrosion sensor 400 through bonding pads 420-1 and 420-2 can measure the value of the capacitor's capacitance through well-known techniques. When exposed to a corrosive environment, the corrodible conductive material in comb patterns 410-1 and 410-2 undergoes corrosion, and the capacitance changes as a consequence of the corrosion. Measurements of the capacitance can be used to estimate the extent of corrosion.

Although FIG. 4 depicts interdigitated comb patterns, it will be clear to those skilled in the art, after reading this disclosure, how to make and use embodiments of the present invention wherein other patterns are used. In particular, whenever two, or more, patterns of conductive material are near enough to one another to achieve a measurable capacitance, if such patterns are made out of corrodible material, the measurable capacitance will change as a consequence of the corrosion. Measurements of the capacitance can then be used to estimate the extent of corrosion.

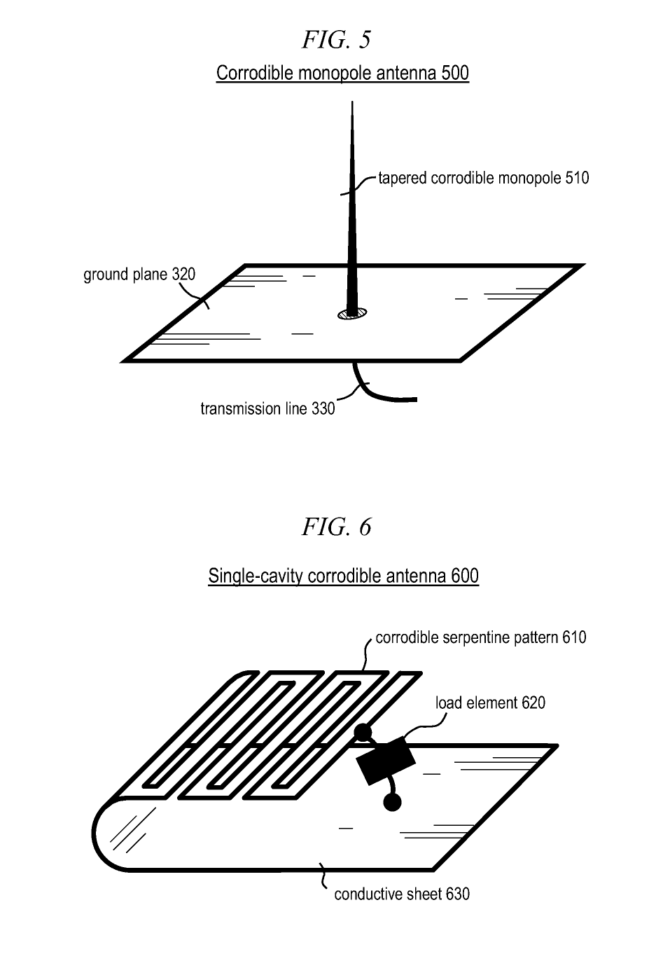

FIG. 5 depicts corrodible monopole antenna 500 in accordance with a first illustrative embodiment of the present invention. Corrodible monopole antenna 500 comprises: tapered corrodible monopole 510, ground plane 320, and transmission line 330, interrelated as shown.

Corrodible monopole antenna 500 is similar to monopole antenna 300, except for tapered corrodible monopole 510, which, unlike monopole 310, is made of a corrodible material, and is tapered. When corrodible monopole antenna 500 undergoes corrosion, its length decreases as the corrodible material is corroded. For a monopole antenna, the center frequency depends on the length of the monopole. A shorter length yields a higher center frequency. Therefore, as tapered corrodible monopole 510 undergoes corrosion, the center frequency of corrodible monopole antenna 500 increases, and the extent of that increase can be used to estimate the extent of corrosion.

In the first illustrative embodiment of the present invention, corrodible monopole antenna 500 is used in a wireless corrosion sensor which also comprises a radio transceiver coupled to corrodible monopole antenna 500. The transceiver uses corrodible monopole antenna 500 for communicating with a remote system through radio signals that are transmitted or received through corrodible antenna 500. FIG. 12 shows a block diagram of such a system. Because the radio signals pass through corrodible antenna 500, they are affected by the antenna's radio-frequency characteristics. In particular, when the center frequency of the antenna changes, the effectiveness with which the radio signals are handled by the antenna also changes.

There are techniques well known in the art for estimating the center frequency of an antenna. For example, and without limitation, the center frequency of an antenna can be estimated by examining the effectiveness with which the antenna handles radio signals of different frequencies. In particular, the frequency of transmitted signals might be varied in a stepwise fashion while recording the strength of the signals as received by a receiver. Alternatively, the phase of the signals, as received by a receiver, might be recorded. Other techniques also exist. It will be clear to those skilled in the art, after reading this disclosure, how to estimate the center frequency of corrodible antenna 500. The estimate of the center frequency can then be used to derive an estimate of the extent of corrosion experienced by tapered corrodible monopole 510. Such an estimate, in turn, can be used to estimate the extent of corrosion of an object near corrodible monopole antenna 500.

Although corrodible monopole antenna 500 is depicted as a monopole antenna, it will be clear to those skilled in the art, after reading this disclosure, how to make and use embodiment of the present invention with other types of corrodible antennas. Antennas are commonly made of metal, and a corrodible antenna can be made by using a corrodible metal or other corrodible material to make part or all of the antenna. Antennas are generally made with precisely shaped and sized parts in order to achieve a desired set of antenna characteristics, and those parts are made of materials with precisely defined electrical parameters. For example, and without limitation, radio-frequency characteristics of an antenna comprise:
i. center frequency,
ii. efficiency,
iii. attenuation,
iv. gain,
v. directivity,
vi. impedance,
vii. radiation pattern,
viii. polarization response,
ix. lobes,
   and many others. Radio-frequency characteristics of an antenna are directly affected by the size and shape of the various parts of an antenna, and also by the electrical properties of the materials from which the parts are made. If any portion of an antenna is made of a corrodible material, some radio-frequency characteristics of the antenna are likely to change as the corrodible material undergoes corrosion.

A change in any one of the radio-frequency characteristics of an antenna can be estimated remotely by sending a radio signal to the antenna, or by receiving a radio signal from the antenna, or both. A radio signal that passes through the antenna is affected by changes in the radio-frequency characteristics of the antenna. A suitably-designed radio signal can be used to probe a particular radio-frequency characteristic, and the change in that radio-frequency characteristic can be estimated from how the radio signal is affected by the antenna. It will be clear to those skilled in the art, after reading this disclosure, how to make and use embodiments of the present invention wherein a radio-frequency characteristic of an antenna that comprises one or more corrodible parts is probed by means of a radio signal.

FIG. 6 depicts single-cavity corrodible antenna 600 in accordance with a second illustrative embodiment of the present invention. Single-cavity corrodible antenna 600 comprises: corrodible serpentine pattern 610, and conductive sheet 630. FIG. 6 also shows load element 620, which is not part of the antenna.

Single-cavity corrodible antenna 600 is made out of a sheet of metal folded into the shape of a cavity. Serpentine pattern 610 is a portion of the metal sheet that has been further shaped into a strip of metal with a serpentine shape, as depicted in FIG. 6. The impedance of single-cavity corrodible antenna 600 depends on the shape and electrical resistance of the serpentine pattern, which is made out of a corrodible material. As the serpentine pattern undergoes corrosion, its shape might change because part of it is corroded away, and its resistance might also change because of the loss of material and because of the chemical changes due to corrosion. As a result, the impedance of single-cavity corrodible antenna 600 might change. Other radio-frequency characteristics of single-cavity corrodible antenna 600 might also change.

Load element 620 is a radio circuit capable of receiving a radio-frequency signal generated by single-cavity corrodible antenna 600, and of transmitting a radio-frequency signal to single-cavity corrodible antenna 600. For example, and without limitation, load element 620 might be a passive-RFID radio circuit. With such a circuit, the combination of single-cavity corrodible antenna 600 and load element 620 can be used as a passive RFID tag. As such, it can be interrogated by a passive-RFID interrogator. FIG. 12 shows a block diagram of a remote system that can be used as an interrogator for the purpose of estimating extent of corrosion.

As the impedance of single-cavity corrodible antenna 600 changes due to corrosion, the interrogator is able to detect the changed impedance by observing the radio signal returned by the passive RFID tag. The interrogator is able to estimate the extent of corrosion from the extent to which the returned radio signal is affected. In an extreme case, corrosion might be so extensive that electrical continuity in the serpentine pattern is interrupted, such that the RFID tag might cease to function. The amount of material in serpentine pattern 610 can be adjusted at the time of manufacture in such a way that cessation of RFID functionality occurs at a precisely defined extent of corrosion. When that happens, the interrogator will be able to estimate that the extent of corrosion has surpassed that precisely defined extent.

In some embodiments of the present invention, a plurality of RFID tags might be used wherein different tags have serpentine patterns with different amounts of material. As different tags cease to function when corrosion reaches different extents, the interrogator is able to accurately estimate the progression of corrosion.

In alternative embodiments of the present invention, a single RFID circuit might be interconnected with a plurality of corrodible antennas to achieve a functionality similar to the one described in the previous paragraph.

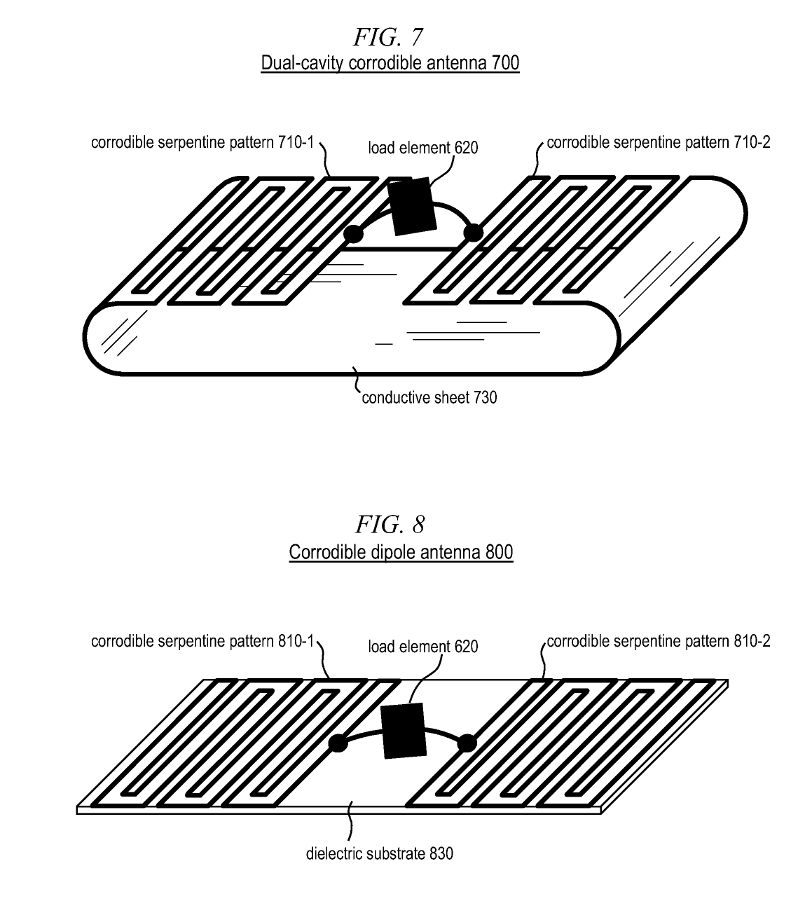

FIG. 7 depicts dual-cavity corrodible antenna 700 in accordance with a third illustrative embodiment of the present invention. Dual-cavity corrodible antenna 700 comprises: corrodible serpentine patterns 710-1 and 710-2, and conductive sheet 730. FIG. 7 also shows load element 620, which is not part of the antenna and is identical to load element 620 described in conjunction with FIG. 6.

Dual-cavity corrodible antenna 700 is made out of a sheet of metal folded into the shape of a double cavity. Serpentine patterns 710-1 and 710-2 are portions of the metal sheet that have been further shaped each into a strip of metal with a serpentine shape, as depicted in FIG. 7. The impedance of dual-cavity corrodible antenna 700 depends on the shapes and electrical resistances of the serpentine patterns, which are made out of a corrodible material. As the serpentine patterns undergo corrosion, their shapes might change, and their resistances might also change. As a result, the impedance of dual-cavity corrodible antenna 700 might change. Other radio-frequency characteristics of dual-cavity corrodible antenna 700 might also change. The comments that were made for single-cavity corrodible antenna 600 also apply for dual-cavity corrodible antenna 700.

FIG. 8 depicts corrodible dipole antenna 800 in accordance with a fourth illustrative embodiment of the present invention. Corrodible dipole antenna 800 comprises: corrodible serpentine patterns 810-1 and 810-2, and dielectric substrate 830. FIG. 8 also shows load element 620, which is not part of the antenna and is identical to load element 620 described in conjunction with FIG. 6.

Corrodible serpentine patterns 810-1 and 810-2 are made out of flat sheets of metal that have been shaped each into a strip of metal with a serpentine shape, as depicted in FIG. 8. Dielectric substrate 830 is a flat sheet of dielectric material with sufficient mechanical rigidity and strength to provide mechanical support for the serpentine patterns and for the load element. Because dielectric substrate 830 provides mechanical support, the serpentine patterns can be made very thin; for example, they might be deposited onto dielectric substrate 830 using so-called thin-film technology.

Corrodible serpentine patterns 810-1 and 810-2 are made out of a corrodible material, and the ability to make them very thin might be advantageous because a thinner serpentine undergoes corrosion faster. The depictions of FIG. 6 and FIG. 7 do not show a dielectric material, but it will be clear to those skilled in the art, after reading this disclosure, how to make and use embodiments of the present invention that use antennas similar to those depicted in FIGS. 6 and 7 wherein the serpentine patterns are supported by a dielectric material. In particular, a dielectric material might be used to fill all or part of the cavities of those antennas. Therefore, thin-film technology can also be used to make very thin serpentine patterns for the antennas depicted in FIGS. 6 and 7.

The impedance of corrodible dipole antenna 800 depends on the shapes and electrical resistances of the serpentine patterns. As the serpentine patterns undergo corrosion, their shapes might change, and their resistances might also change. As a result, the impedance of corrodible dipole antenna 800 might change. Other radio-frequency characteristics of corrodible dipole antenna 800 might also change. The comments that were made for single-cavity corrodible antenna 600 also apply for corrodible dipole antenna 800.

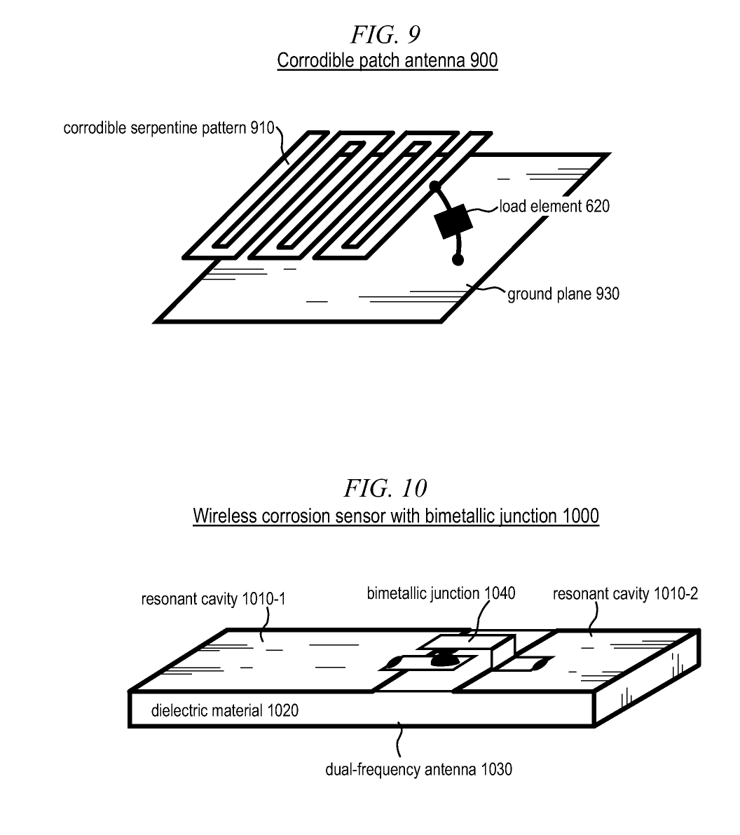

FIG. 9 depicts corrodible patch antenna 900 in accordance with a fifth illustrative embodiment of the present invention. Corrodible patch antenna 900 comprises: corrodible serpentine pattern 910, and ground plane 930. FIG. 9 also shows load element 620, which is not part of the antenna and is identical to load element 620 described in conjunction with FIG. 6.

Ground plane 930 is made out of one flat sheet of metal, and corrodible serpentine pattern 910 is made out of another flat sheet of metal that has been shaped into a strip of metal with a serpentine shape, as depicted in FIG. 9. The impedance of corrodible patch antenna 900 depends on the shape and electrical resistance of the serpentine pattern, which is made out of a corrodible material. As the serpentine pattern undergoes corrosion, its shape might change, and its resistance might also change. As a result, the impedance of corrodible patch antenna 900 might change. Other radio-frequency characteristics of corrodible patch antenna 900 might also change. The comments that were made for single-cavity corrodible antenna 600 also apply for corrodible patch antenna 900.

Although the depiction of FIG. 9 does not show a dielectric substrate, it will be clear to those skilled in the art, after reading this disclosure, how to make and use embodiments of the present invention that use antennas like corrodible patch antenna 900 wherein the serpentine pattern is supported by a dielectric substrate. In particular, a dielectric material might be used to fill all or part of the space between corrodible serpentine pattern 910 and ground plane 930. Therefore, thin-film technology can be used to make serpentine pattern 910.

FIG. 10 depicts wireless corrosion sensor with bimetallic junction 1000 in accordance with a sixth illustrative embodiment of the present invention. Wireless corrosion sensor with bimetallic junction 1000 comprises: dual-frequency antenna 1030, and bimetallic junction 1040. Dual-frequency antenna 1030 comprises resonant cavity 1010-1, resonant cavity 1010-2, and dielectric material 1020.

The two resonant cavities of dual-frequency antenna 1030 are shaped so as to resonate at two different frequencies such that the antenna provides good performance at both frequencies. In particular, the two cavities are shaped such that one frequency is the third harmonic of the other frequency (hereinafter referred to as “third harmonic” and “fundamental”, respectively). Dielectric material 1020 fills the space inside the two cavities and provides mechanical support for the entire structure. Bimetallic junction 1040 is connected to the antenna at the antenna's input-output port. It performs the function of a radio circuit for wireless corrosion sensor 1000. Bimetallic junction 1040 is made of corrodible material.

In accordance with this illustrative embodiment of the present invention, when a fundamental radio signal is received by the antenna, the resulting radio-frequency signal is applied to bimetallic junction 1040. If corrosion has occurred in bimetallic junction 1040, the junction has a characteristic of non-linearity.

Because of the non-linearity, some of the radio-frequency signal—which has the same fundamental frequency as the received radio signal—is converted into another radio-frequency signal at the third-harmonic frequency. Because the antenna is made to have good performance at the third harmonic frequency, this third-harmonic radio-frequency signal is efficiently converted into a radio signal that is transmitted by the antenna.

The strength of the third-harmonic radio signal that is transmitted depends on the strength of the non-linearity, which, in turn, depends on the extent of corrosion that has occurred. Therefore, a remote system can estimate the extent of corrosion by transmitting a radio signal at the fundamental frequency to wireless corrosion sensor with bimetallic junction 1000. FIG. 12 shows a block diagram of such a remote system. In response to the fundamental radio signal, the wireless corrosion sensor transmits a third-harmonic radio signal whose strength reflects the extent of corrosion. The remote system can detect the third harmonic and estimate the extent of corrosion from the observed strength of the third harmonic, for example.

Although the previous paragraph illustrates how the strength of the third harmonic can be used for estimating the non-linearity and, through that, the extent of corrosion, it will be clear to those skilled in the art, after reading this disclosure, how to make and use embodiments of the present invention wherein other signal parameters are used to estimate the non-linearity. For example, and without limitation, the phase of the third harmonic might be used for estimating the non-linearity. In particular, as detailed below, systems can detect multiple harmonics. Such systems can examine the relative phases between different harmonics and use those relative phases for estimating the non-linearity.

Although wireless corrosion sensor with bimetallic junction 1000 is depicted with a dual-frequency antenna optimized for a fundamental frequency and a third-harmonic frequency, it will be clear to those skilled in the art, after reading this disclosure, how to make and use embodiments of the present invention wherein the antenna is optimized for a different set of frequencies. For example, and without limitation, the antenna might be optimized for the fundamental frequency and a different harmonic frequency, such as the second harmonic, or the fourth harmonic, or another harmonic frequency. Also, the antenna might be optimized for a pair of harmonic frequencies other than the fundamental frequency; for example, the antenna might be optimized for the second harmonic and the third harmonic frequencies, or for another pair of harmonic frequencies. It is well known in the art that harmonic frequencies exist for all natural numbers, with the first harmonic being the same as the fundamental frequency.

It will also be clear to those skilled in the art, after reading this disclosure, that the set of frequencies for which the antenna is optimized can comprise more than two frequencies. It is well known in the art how to make antennas that are optimized for more than just two frequencies. For example, the antenna might be optimized for three frequencies: the fundamental, the second harmonic and the third harmonic. In general, a non-linearity can be expected to generate more than one harmonic frequency and the remote system can detect any number of those harmonics. It will be clear to those skilled in the art, after reading this disclosure, how an improved estimate of corrosion can be achieved in the remote system by comparing multiple detected harmonics to one another.

This illustrative embodiment of the present invention probes the non-linearity of bimetallic junction 1040 by means of a periodic radio signal that is received by wireless corrosion sensor with bimetallic junction 1000. The non-linearity is estimated by examining harmonics of the radio signal. However, it will be clear to those skilled in the art, after reading this disclosure, how to make and use embodiments of the present invention wherein other types of signals are used to probe the non-linearity of bimetallic junction 1040, and/or wherein other resulting signals—i.e., other than harmonics—are examined for the purpose of estimating the non-linearity. For example, and without limitation, a two-tone signal might be used for probing the non-linearity. Such a signal typically comprises two periodic signals with frequencies that, though different from one another, are relatively close to one another. For example, the two frequencies might differ by about 1%.

When a two-tone signal is used for probing a non-linearity, an estimate of the non-linearity can be achieved by examining the so-called intermodulation products. For example, the so-called third-order intermodulation products are frequently examined for such a purpose. Other intermodulation products might also be examined to obtain additional information leading to an improved estimate of non-linearity.

One important advantage of using intermodulation products for probing a non-linearity is that many such products occur at frequencies that are not very different from the frequencies used to probe the non-linearity. For example, if the frequencies of the two tones in a two-tone signal differ by 1%, third-order intermodulation products might appear, as a consequence of non-linearity, at frequencies that are 1% above the higher of the two tone frequencies, and 1% below the lower of the two tone frequencies. This fact makes antenna design easier. Other intermodulation products might appear near harmonic frequencies of the two tone frequencies.

It will be clear to those skilled in the art, after reading this disclosure, how to make and use embodiments of the present invention which use two-tone signals, or multi-tone signals, or other types of signals, for probing the non-linearity of bimetallic junction 1040. It will also be clear to those skilled in the art, after reading this disclosure, how to make and use embodiments of the present invention wherein intermodulation products are used for estimating the non-linearity. Such intermodulation products might be used, for the purpose of estimating the non-linearity, individually or jointly with other intermodulation products, or jointly with harmonics. Observed relationships between intermodulation products or between intermodulation products and harmonics might be used for the purpose of estimating the non-linearity. Such observed relationships might comprise, for example and without limitation, relative strength and relative phase. It will be clear to those skilled in the art, after reading this disclosure, how to achieve an estimate of the non-linearity by examining such relationships.

Although FIG. 10 depicts a bimetallic junction formed by two metals in contact with one another, it will be clear to those skilled in the art, after reading this disclosure, how to make and use embodiments of the present invention wherein a different element is used that exhibits a characteristic of non-linearity in response to corrosion, or a characteristic of non-linearity whose behavior changes in response to corrosion.

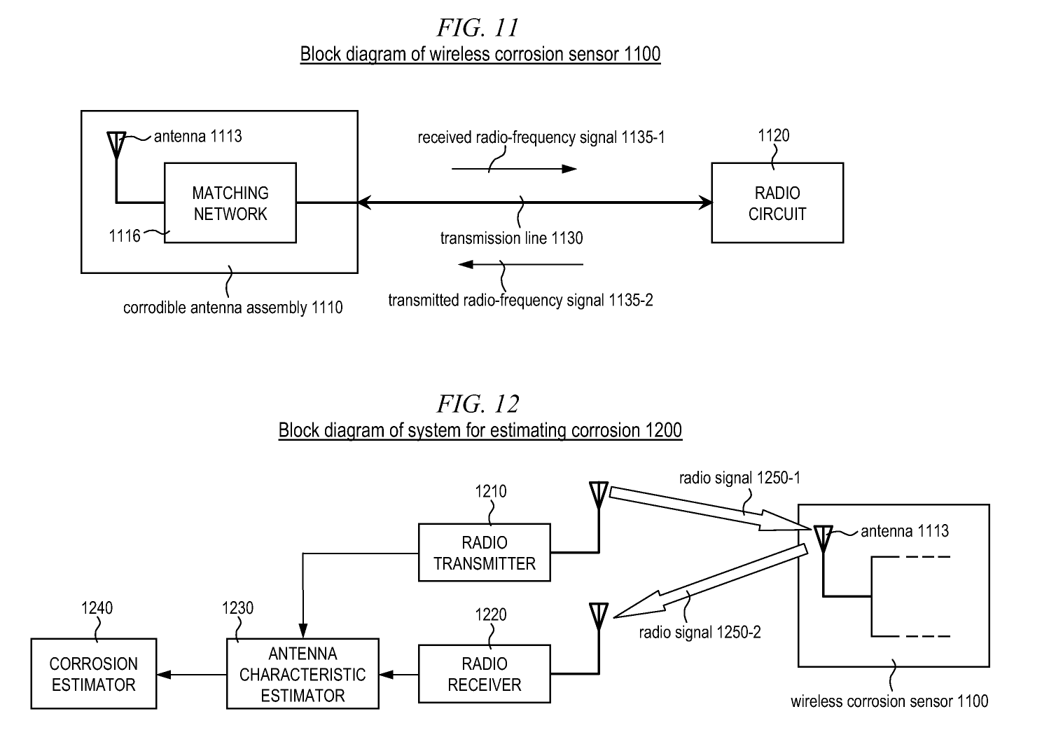

FIG. 11 shows a block diagram of wireless corrosion sensor 1100 in accordance with some embodiments of the present invention. Wireless corrosion sensor 1100 comprises: corrodible antenna assembly 1110, radio circuit 1120 coupled with corrodible antenna assembly 1110 through transmission line 1130. Corrodible antenna assembly 1110 comprises antenna 1113 and matching network 1116.

Corrodible antenna assembly 1110 comprises a corrodible material. For example, antenna 1113 might be one of the antennas depicted in FIGS. 5-9, which comprise a corrodible material; alternatively, matching network 1116 might comprise a corrodible material; or both. The presence of a corrodible material in the antenna assembly means that, as corrosion occurs, one or more of the radio-frequency characteristics of the antenna assembly changes in response to the corrosion. Possible radio-frequency characteristics of the antenna assembly comprise all the radio-frequency characteristics listed for antennas in the comments for FIG. 5, and others. For example, and without limitation, other radio-frequency characteristics comprise:
i. filtering characteristics,
ii. impedance conversion,
iii. diplexing,
iv. duplexing,
v. splitting ratio,
vi. combining ratio,
vii. insertion loss,
viii. directionality,
   and many others. If a portion of the antenna assembly is made of a corrodible material, some radio-frequency characteristics of the antenna assembly are likely to change as the corrodible material undergoes corrosion.

Radio circuit 1120 is coupled with corrodible antenna assembly 1110 through transmission line 1130, which carries received radio-frequency signal 1135-1 from the antenna assembly to the radio circuit, and transmitted radio-frequency signal 1135-2 from the radio circuit to the antenna assembly. Received radio-frequency signal 1135-1 is generated by the antenna assembly in response to a received radio signal, and transmitted radio-frequency signal 1135-2 results in a radio signal transmitted by the antenna assembly. Radio circuit 1120 generates transmitted radio-frequency signal 1135-2 in response to received radio-frequency signal 1135-1.

In wireless corrosion sensor 1100, a single antenna is used for receiving the received radio signal and for transmitting the transmitted radio signal in response to the first radio signal. However, it will be clear to those skilled in the art, after reading this disclosure, how to make and use embodiments of the present invention wherein corrodible antenna assembly comprises multiple antennas. For example, and without limitation, corrodible antenna assembly 1110 might comprise separate antennas for transmitting and receiving. The antenna assembly might also comprise multiple antennas for the purpose of having different antennas with different characteristics that change in response to corrosion. An antenna might be made with a corrodible material that, in response to corrosion, causes the antenna to cease to function when corrosion reaches a certain extent. Antenna assembly 1110 might have a plurality of such antennas, each designed to cease to function at a different extent of corrosion, thus providing a convenient method for assessing the extent of corrosion that has occurred. Similarly, multiple radio circuits might be present for handling multiple received and transmitted radio-frequency signals.

Some embodiments of the present invention might not need a matching network. In such embodiments, matching network 1116 is not present, and the antenna assembly consists of just one or more antennas. Other embodiments might comprise other types of radio-frequency devices, components or elements in the antenna assembly.

The radio circuit processes the received signal and generates the transmitted signal in response to it. It will be clear to those skilled in the art, after reading this disclosure, how to make and use a variety of radio circuits suitable for wireless corrosion sensor 1100. In particular, radio circuit 1120 might be an RFID radio circuit, which is a type of radio circuit well known in the art. In contrast, some embodiments of the present invention might utilize bimetallic junction 1040, as disclosed in conjunction with FIG. 10, as a radio circuit that is sensitive to corrosion and particularly easy to implement; in such embodiments, the antenna assembly does not have to comprise a corrodible material.

Although FIG. 11 shows a transmission line for connecting the antenna assembly to the radio circuit, it will be clear to those skilled in the art, after reading this disclosure, how to make and use embodiments of the present invention wherein the radio circuit and the antenna assembly are coupled to one another in a different way. For example, and without limitation, the radio circuit might be directly connected to the antenna assembly without the need for an intervening transmission line. Such an arrangement is exemplified in FIGS. 6 through 9, where load element 620 is the radio circuit and is connected directly to the antenna.

Although FIG. 11 shows a radio circuit that has a single input-output port connected to transmission line 1130, it will be clear to those skilled in the at, after reading this disclosure, how to make and use embodiments of the present invention wherein the radio circuit has more than one port. In particular, in embodiments where the antenna assembly comprises multiple antennas, the radio circuit might have multiple ports for connecting to the antennas. Alternatively, embodiments with multiple antennas might comprise multiple radio circuits independently connected to the antennas, or a combination of radio circuits with single ports and with multiple ports interconnected with the antennas in a variety of ways.

FIG. 12 shows a block diagram of system for estimating corrosion 1200 in accordance with some embodiments of the present invention. System for estimating corrosion 1200 comprises: wireless corrosion sensor 1100 comprising antenna 1113, radio transmitter 1210, radio receiver 1220, antenna characteristic estimator 1230, and corrosion estimator 1240, interrelated as shown.

Radio transmitter 1210 transmits radio signal 1250-1, which is received by wireless corrosion sensor 1100. Antenna 1113 of wireless corrosion sensor 1100 might, for example, be one of the corrodible antennas of FIGS. 5 through 9. Through its radio circuit, wireless corrosion sensor 1100 responds to the received radio signal by transmitting radio signal 1250-2 as a response.

Radio signal 1250-2 is received by radio receiver 1220, and some of the parameters of radio signal 1250-2, as received, are transmitted to antenna characteristic estimator 1230 by radio receiver 1220. Some such parameters might be, for example and without limitation, the strength of radio signal 1250-2 as received, or its frequency, or its polarization, or its distortion, or its harmonics, or any of the parameters that are well know in the art for characterizing a radio signal.

Antenna characteristic estimator might also receive, from radio transmitter 1210, some of the parameters of radio signal 1250-1, as transmitted. Antenna characteristic estimator then estimates a radio-frequency characteristic of antenna 1113. Such estimation can be based, for example, on a comparison of parameters of radio signal 1250-1, as transmitted, with parameters of radio signal 1250-2, as received. Alternatively, antenna characteristic estimator 1230 might compare parameters of radio signal 1250-2, as received, with stored data. For example, the stored data might be previous values of parameters of radio signal 1250-2, as received, obtained at a previous time or times.

In any case, antenna characteristic estimator 1230 generates an estimate of a characteristic of antenna 1113. In this example, wherein antenna 1113 is one of the corrodible antennas of FIGS. 5 through 9, the estimate of a characteristic of the antenna reflects the extent of corrosion of the antenna. Such an estimate is then transmitted by antenna characteristic estimator 1230 to corrosion estimator 1240. Corrosion estimator 1240 has knowledge of antenna 1113; in particular, it knows how the characteristics of antenna 1113 are affected by corrosion, and can, therefore, estimate the extent of corrosion of antenna 1113 from the estimate that it receives from antenna characteristic estimator 1230.

FIG. 12 shows simple arrows interconnecting blocks 1210, 1220, 1230, and 1240. Such arrows are meant to show the flow of information or data between the blocks. It will be clear to those skilled in the art, after reading this disclosure, how to make and use embodiments of the present invention wherein those blocks are coupled to one another in a variety of ways well known in the art. For example, and without limitation, the blocks might be coupled with one another through direct electrical connections, through digital channels such as those in a local-area network (LAN) or the internet, through wireless links, or through any links well known in the art that provide the necessary connectivity. Some of the blocks might be located near one another; they might even, possibly, be implemented as part of the same electronic circuitry. Alternatively, different blocks might be located at large distances from one another and interconnected via long-distance links. If blocks are widely separated, transmission of information or data from one block to another might require specialized interfaces, such as, for example, a LAN interface. Alternatively, if blocks are collocated, transmission might be achieved, for example, with a simple wire or by sharing data in a shared digital memory. Blocks are typically implemented with electronic circuits, and such electronic circuits might comprise one or more processors for executing software. The connection between block 1210 and block 1230 might not be necessary in some embodiments of the present invention.

Although block 1230 is identified as an antenna characteristic estimator, it will be clear to those skilled in the art, after reading this disclosure, how to make and use embodiments of the present invention that use a corrodible antenna assembly 1110 with corrodible material in parts of the assembly other than the antenna. Such embodiments will have a block equivalent to block 1230 for estimating a radio-frequency characteristic of corrodible antenna assembly 1110 that is affected by corrosion. In a similar fashion, embodiments of the present invention that use a wireless corrosion sensor with a bimetallic junction, as in FIG. 10, will have a block equivalent to block 1230 for estimating a non-linearity of the bimetallic junction. In all such embodiments, block 1230, or its equivalent, transmits its estimate to block 1240 for generating an estimate of the extent of corrosion.

Although FIG. 12 shows only one radio transmitter, only one radio receiver and only one wireless corrosion sensor, it will be clear to those skilled in the art, after reading this disclosure, how to make and use embodiments of the present invention with multiple radio transmitter, or with multiple radio receivers, or with multiple wireless corrosion sensors, or with combinations of these variants. In particular, some embodiments of the present invention might comprise a radio transceiver that is, in all respects, identical to wireless corrosion sensor 1100, except that it does not contain any corrodible material. Strictly speaking, such a device cannot be considered a “corrosion sensor”. It will be referred to as a “reference radio transceiver”.

A reference radio transceiver is advantageous in a system such as in FIG. 12 because the radio signal transmitted by the reference radio transceiver is representative of what the signal transmitted by a wireless corrosion sensor would be in the absence of corrosion. Antenna characteristic estimator 1230 can improve the accuracy of its estimate by comparing radio signal 1250-2, as received, to the radio signal from a reference radio transceiver, as received.

It will be clear to those skilled in the art, after reading this disclosure, that a reference radio transceiver does not necessarily have to be identical to wireless corrosion sensor 1100, except for the corrodible material. It is sufficient to have a reference radio transceiver whose performance, relative to wireless corrosion sensor 1100, is known to antenna characteristic estimator 1230. Such knowledge might be achieved, for example, through a calibration. In any case, with such knowledge, antenna characteristic estimator 1230 can monitor the radio signal from wireless corrosion sensor 1100 as it changes through time in response to corrosion, while using the signal from a reference radio transceiver as a reference that is not affected by corrosion.

It is to be understood that this disclosure teaches just one or more examples of one or more illustrative embodiments, and that many variations of the invention can easily be devised by those skilled in the art, after reading this disclosure, and that the scope of the present invention is to be determined by the claims accompanying this disclosure.

### MARKMAN DEFINITIONS

Antenna—For the purposes of this patent application, an “antenna” is defined as a device for converting an electrical radio-frequency signal into a radio signal, or vice versa, or both. Typically, an antenna is made out of one or more pieces of metal suitably sized, shaped, and arranged. Antennas might also comprise dielectric materials, in addition to metal. Conductive materials other than metals are sometimes used.

Antennas are, intrinsically, reciprocal devices: a “transmitting” antenna can be used as a “receiving” antenna for the same type of radio signals that it can transmit. The adjectives “transmitting” and “receiving” are commonly used in the art to identify how an antenna is being used, but they do not imply a physical or electrical specialization of the antenna per se for either function.

A simple antenna has a single input-output port (sometimes implemented with a radio-frequency connector). Such an antenna, when used for transmission, accepts a radio-frequency signal at its input-output port and transmits a radio signal derived from the radio-frequency signal. The same antenna, when used for reception, receives a radio signal and generates, at the input-output port, a radio-frequency signal derived from the radio signal. More complex antennas might have multiple input-output ports and might be capable of transmitting and/or receiving multiple radio signals. Antennas can simultaneously receive and transmit radio signals.

Antenna assembly—An “antenna” is defined above narrowly as a device for converting an electrical radio-frequency signal into a radio signal, or vice versa, or both. In practice, there are other passive functionalities such as, for example, filtering, impedance matching, signal splitting and combining, duplexing and diplexing (i.e., separating signals based on frequency, polarization, direction of propagation, etc.), to name just a few, that are often needed for enabling an antenna to perform its function. Such passive functionalities are not, strictly speaking, part of the conversion of a radio-frequency signal into a radio signal or vice versa; however, they are often implemented with structures closely coupled with the antenna and similar to the structures used for implementing antennas. In this patent application, “antenna assembly” is used to refer to the block of components that comprises the antenna proper and also those passive components needed for enabling the antenna to perform its function.

Based on—For the purposes of this patent application, the phrase “based on” is defined as “being dependent on” in contrast to “being independent of”. Being “based on” includes both functions and relations.

Bimetallic—For the purposes of this patent application, the word “bimetallic” is defined as “consisting of two metals”. In particular, a “bimetallic junction” is an electrical component wherein two metals come in contact with one another. The two metals might be just touching one another, or they might be attached to one another by, for example, a weld or other type of connection. When an electrical current passes through a bimetallic junction, the response of the junction might depend on the extent of corrosion that has occurred near the point of contact. Such response might be characterized by non-linearity.

Note: For the purposes of this definition of “bimetallic” the word “metal” should be interpreted broadly to refer to any electrically conductive material that can be used to form a junction with another such material such that the junction develops non-linearity in response to corrosion.

Coupled—In Physics, two systems are said to be “coupled” if they are interacting with each other. Accordingly, for the purposes of this patent application, the word “coupled” is used to denote a relationship between items whereby one item affects another, or vice versa, or both. In particular, for example, two electrical circuits that are coupled with one another might be directly connected to one another, or might be connected through intervening items such as, for example, wires, transmission lines, components, other circuits, etc., in such a way that one of the two electrical circuits can affect the other, or vice versa, or both.

Corrodible—The American Heritage Dictionary, third edition, defines “corrodible” as an adjective that derives from the verb “to corrode”, for which the first definition given by the dictionary is: “To destroy a metal or alloy gradually, especially by oxidation or chemical action”. For the purposes of this patent application, “corrodible” is used in reference to materials or objects that are subject to being corroded in accordance with that definition.

Dielectric—In this patent application, the word “dielectric” is used both as a noun and as an adjective to refer to a material that is electrically insulating (adjective) or an electrical insulator (noun).

Electronic circuit—The American Heritage Dictionary, third edition, provides several definitions for the noun “circuit”. One of them is: “A configuration of electrically or electromagnetically connected components or devices”. This is the definition to be used for “Electronic circuit” for the purposes of this patent application. In particular, the use of the adjective “electronic” means that the circuit comprises electronic devices such as transistors.

To Exhibit—For the purposes of this patent application, the infinitive “to exhibit” and its inflected forms (e.g., “exhibiting”, “exhibits”, etc.) is defined as “to manifest or make evident”.

Fundamental—In this patent application, the word “fundamental” is used as a synonym for “first harmonic”, as is common in the art.

To Generate—For the purposes of this patent application, the infinitive “to generate” and its inflected forms (e.g., “generating”, “generation”, etc.) should be given the ordinary and customary meaning that the terms would have to a person of ordinary skill in the art at the time of the invention.

Harmonic—In this patent application, the word “harmonic” is used both as a noun and as an adjective with the meaning known in the art in the context of Fourier analysis. In particular, through Fourier analysis, a periodic signal can be expressed as the sum of a plurality of sinusoidal signals at frequencies that are multiples of the frequency of the periodic signal. The sinusoidal signals are known as harmonics and their frequencies are known as harmonic frequencies. The sinusoidal signal that has the same frequency as the periodic signal is known as the first harmonic (also, as the fundamental) and its frequency is known as the first harmonic frequency; the sinusoidal signal that has double the frequency as the periodic signal is known as the second harmonic and its frequency is known as the second harmonic frequency; the sinusoidal signal that has treble the frequency as the periodic signal is known as the third harmonic and its frequency is known as the third harmonic frequency; and so on.

The use of ordinal numbers (first, second, third, etc.) to identify harmonics, though common in the art, interferes with the also common practice of using ordinal numbers in claim language for the purpose of distinguishing different instances of the same entity. Therefore, in this patent application, when referring to harmonics in a claim, a second harmonic is referred to as a “so-called second harmonic”, a third harmonic is referred to as a “so-called third harmonic”, etc., so that the ordinal numbers can continue to be used in the claims with the usual meaning. In particular, when more than one harmonic appears in a claim, the first instance is referred to as “a first harmonic” and if it is a specific harmonic of a periodic signal—for example, a second harmonic—it is referred to as a “first so-called second harmonic”, and so on.

Non-linearity—For the purposes of this patent application, a “non-linearity” is defined as the characteristic of not being linear. A “linear” relationship is defined in mathematics as a relationship between quantities whereby, in a somewhat simplified description, when one quantity changes by a certain factor (for example, it doubles), a linearly-related quantity changes by the same factor (it also doubles). A device or component is typically referred to as linear if it is characterized by a linear relationship between its salient parameters. For example, resistors, capacitors and inductors are linear devices because the relationship between voltage and current is linear in those devices. It is well known in the art that a linear device responds to a radio-frequency signal with a response that is at the same frequency as the frequency of the radio-frequency signal, while a non-linear device responds at different frequencies. For example, a non-linear device might generate harmonics or intermodulation products.

Processor—For the purposes of this patent application, a “processor” is defined as hardware or hardware and software that performs mathematical and/or logical operations. The processors described in the illustrative embodiments might have more limitations than processors in the claims.

Radio circuit—For the purposes of this patent application, a “radio circuit” is defined as an electrical circuit for processing a radio-frequency signal. For example, a radio circuit might be used for generating a radio-frequency signal, or for accepting a radio-frequency signal, or both. A radio circuit might generate more than one radio-frequency signal, or might accept more than one radio-frequency signal, or both.

Radio-frequency—For the purposes of this patent application, the hyphenated group “radio-frequency” is used exclusively as an adjective to denote something that has to do with radio signals but is not, itself, a radio signal. The abbreviation “RF” is used with the same meaning. This definition is somewhat narrower than the use of “radio-frequency” and “RF” in the art, where it is sometimes used as a noun to refer to an actual radio signal.

Radio-frequency characteristic—For the purposes of this patent application, a “radio-frequency characteristic” is defined as a characteristic of an element, component, device or system used for radio communications that reflects the functionality of such element, component, device or system in regard to radio signals or radio-frequency signals.

Radio-frequency Identification (abbreviated as: RFID)—This expression is commonly used in the art to refer to a technique for tracking objects and/or storing and retrieving information about objects wirelessly by means of radio signals. The technique is typically implemented through the use of radio communicators that are attached to the objects and are known as RFID tags.

Radio-frequency signal—For the purposes of this patent application, a “radio-frequency signal” is defined as a signal that is representative of a radio signal, but that is supported by a material medium. For example, when an antenna receives a radio signal, it generates an electrical signal at its input-output port that is derived from the received radio signal. The input-output port of the antenna might be a connector made of metal; in which case, the electrical signal is supported by the metal of the connector. Such electrical signal is, according to this definition, a radio-frequency signal. Similarly, a radio transmitter generates a radio signal by first generating an electrical radio-frequency signal that is then fed to an antenna; the antenna generates a radio signal derived from the radio-frequency signal. Material media that support radio-frequency signals comprise conductive materials, such as metals, and dielectric materials. Such materials are used, for example, in transmission lines that carry radio-frequency signals over distances.

Radio receiver—For the purposes of this patent application, a “radio receiver” is defined as an apparatus for receiving a radio signal. Typically, a radio receiver comprises an antenna for converting the radio signal into a radio-frequency signal, and a radio circuit for processing the radio-frequency signal. A radio receiver might be capable of receiving more than one radio signal.

Radio signal—For the purposes of this patent application, a “radio signal” is defined as a signal consisting of an electromagnetic wave that propagates through air or vacuum without needing a material support such as a wire, a connector, or a transmission line.

Radio transceiver—For the purposes of this patent application, a “radio transceiver” is defined as an apparatus that comprises both a radio transmitter and a radio receiver. A radio transceiver might have separate radio circuits for implementing the radio receiver and the radio transmitter functionalities, or it might have a radio circuit that implements both a radio receiver and a radio transmitter functionality, either simultaneously or at different times.

Radio transmitter—For the purposes of this patent application, a “radio transmitter” is defined as an apparatus for transmitting a radio signal. Typically, a radio transmitter comprises a radio circuit for generating a radio-frequency signal, and an antenna for converting the radio-frequency signal into the radio signal. A radio transmitter might be capable of transmitting more than one radio signal.

To Receive—For the purposes of this patent application, the infinitive “to receive” and its inflected forms (e.g., “receiver”, “receiving”, “received”, “reception”, etc.) should be given the ordinary and customary meaning that the terms would have to a person of ordinary skill in the art at the time of the invention. In this patent application, the preposition “over” is used to indicate reception from a supporting medium or channel, as in “receiving over a network”. In contrast, the preposition “through” is used to indicate transmission by means of a supporting medium or channel, as in “transmitting through a network”. The reason for using different prepositions is to enhance clarity. Reception of a radio-frequency signal requires a material medium as in reception over a transmission line or over an electrical connection. Reception of a radio signal over a radio channel occurs over air or vacuum and is accomplished with the use of an antenna.

To Transmit—For the purposes of this patent application, the infinitive “to transmit” and its inflected forms (e.g., “transmitter”, “transmitting”, “transmitted”, “transmission”, etc.) should be given the ordinary and customary meaning that the terms would have to a person of ordinary skill in the art at the time of the invention. In this patent application, the preposition “through” is used to indicate transmission by means of a supporting medium or channel, as in “transmitting through a network”. In contrast, the preposition “over” is used to indicate reception from a supporting medium or channel, as in “receiving over a network”. The reason for using different prepositions is to enhance clarity. Transmission of a radio-frequency signal requires a material medium as in transmission through a transmission line or through an electrical connection. Transmission of a radio signal through a radio channel occurs through air or vacuum and is accomplished with the use of an antenna.

When—For the purposes of this patent application, the word “when” is defined as “upon the occasion of”.

What is claimed is:

1. An apparatus for sensing extent of corrosion; the apparatus comprising:
an antenna assembly; and
a radio circuit for receiving a first radio-frequency signal from the antenna assembly, and for transmitting a second radio-frequency signal to the antenna assembly;
wherein the second radio-frequency signal is based on the first radio-frequency signal;
wherein the antenna assembly generates the first radio-frequency signal based on a received first radio signal;
wherein the antenna assembly generates a transmitted second radio signal based on the second radio-frequency signal;
wherein the antenna assembly comprises a corrodible material;
wherein the corrodible material affects a radio-frequency characteristic of the antenna assembly;
wherein the radio-frequency characteristic of the antenna assembly affects at least one of the first radio-frequency signal and the second radio signal.

2. The apparatus of claim 1 further comprising
a radio transmitter for transmitting the first radio signal;
a radio receiver for receiving the second radio signal;
an electronic circuit for estimating the radio-frequency characteristic of the antenna assembly based on the second radio signal; and
a transmitter, coupled with the electronic circuit, for transmitting the estimated radio-frequency characteristic of the antenna assembly to a corrosion estimator;
wherein the corrosion estimator estimates a corrosion of the corrodible material based on the estimated radio-frequency characteristic of the antenna assembly.

3. The apparatus of claim 2 further comprising a processor for implementing the corrosion estimator.

4. The apparatus of claim 1 wherein the radio-frequency characteristic of the antenna assembly is a center frequency.

5. The apparatus of claim 1 wherein the radio-frequency characteristic of the antenna assembly is an impedance.

6. The apparatus of claim 1 wherein the radio-frequency characteristic of the antenna assembly is an attenuation.

7. The apparatus of claim 2 wherein estimating the radio-frequency characteristic of the antenna assembly is based on the strength of the second radio signal.

8. The apparatus of claim 2 wherein estimating the radio-frequency characteristic of the antenna assembly is based on the phase of the second radio signal.

9. The apparatus of claim 2 further comprising a reference radio transceiver for receiving a third radio signal and transmitting a fourth radio signal;
wherein the third radio signal is transmitted by the radio transmitter; and
wherein estimating the radio-frequency characteristic of the antenna assembly is also based on comparing the second radio signal to the fourth radio signal.

10. The apparatus of claim 9 wherein the first radio signal and the third radio signal are the same signal.

11. The apparatus of claim 1 further comprising a corrodible serpentine pattern that comprises the corrodible material.

12. The apparatus of claim 11 wherein the antenna assembly comprises a single-cavity antenna that comprises the corrodible serpentine pattern.

13. The apparatus of claim 11 wherein the antenna assembly comprises a dual-cavity antenna that comprises the corrodible serpentine pattern.

14. The apparatus of claim 11 wherein the antenna assembly comprises a dipole antenna that comprises the corrodible serpentine pattern.

15. The apparatus of claim 11 wherein the antenna assembly comprises a patch antenna that comprises the corrodible serpentine pattern.

16. The apparatus of claim 11 wherein the corrodible serpentine pattern is supported by a dielectric substrate.

17. An apparatus for sensing extent of corrosion; the apparatus comprising:
an antenna; and
a bimetallic junction coupled with the antenna;
wherein the bimetallic junction comprises a corrodible material;
wherein the corrodible material affects a radio-frequency characteristic of the bimetallic junction;
wherein the radio-frequency characteristic is a non-linearity; and
wherein the non-linearity is affected by the extent of corrosion.

18. The apparatus of claim 17 further comprising
a radio transmitter for transmitting a first radio signal;
a radio receiver for receiving a second radio signal, wherein the second radio signal comprises a first harmonic of the first radio signal;
an electronic circuit for estimating the non-linearity of the bimetallic junction based on the first harmonic; and
a transmitter, coupled with the electronic circuit, for transmitting the estimated non-linearity of the bimetallic junction to a corrosion estimator;
wherein the corrosion estimator estimates a corrosion of the corrodible material based on the estimated non-linearity of the bimetallic junction.

19. The apparatus of claim 18 wherein the first harmonic is a so-called second harmonic.

20. The apparatus of claim 18 wherein the first harmonic is a so-called third harmonic.

21. The apparatus of claim 18 wherein estimating the non-linearity of the bimetallic junction is also based on comparing the first harmonic of the first radio signal to a second harmonic of the first radio signal.

22. The apparatus of claim 17 further comprising
a radio transmitter for transmitting a first radio signal;
a radio receiver for receiving a second radio signal, wherein the second radio signal comprises an intermodulation product of the first radio signal;
an electronic circuit for estimating the non-linearity of the bimetallic junction based on the first intermodulation product; and
a transmitter, coupled with the electronic circuit, for transmitting the estimated non-linearity of the bimetallic junction to a corrosion estimator;
wherein the corrosion estimator estimates a corrosion of the corrodible material based on the estimated non-linearity of the bimetallic junction.

23. The apparatus of claim 22 wherein the first radio signal is a two-tone signal, and the intermodulation product is a third-order intermodulation product.

24. A method for sensing extent of corrosion; the method comprising:
receiving, by an antenna assembly, a first radio signal; and
transmitting, by an antenna assembly, a second radio signal based on the first radio signal;
wherein a characteristic of the second radio signal is affected by an extent of corrosion of a corrodible portion of the antenna assembly.

25. The method of claim 24 further comprising:
transmitting, by a radio transmitter, the first radio signal;
receiving, by a radio receiver, the second radio signal; and
estimating, by a corrosion estimator, the extent of corrosion of the corrodible portion of the antenna assembly;
wherein estimating the extent of corrosion is based on the second radio signal as received by the radio receiver.

26. The method of claim 25 wherein estimating the extent of corrosion is based on an estimated center frequency of the antenna assembly; and
wherein the estimated center frequency of the antenna assembly is based on the second radio signal.

27. The method of claim 25 wherein estimating the extent of corrosion is based on an estimated attenuation of the antenna assembly; and
wherein the estimated attenuation of the antenna assembly is based on the second radio signal.

28. The method of claim 25 wherein estimating the extent of corrosion is based on an estimated impedance of the antenna assembly; and
wherein the estimated impedance of the antenna assembly is based on the second radio signal.

29. The method of claim 25 further comprising:
transmitting, by the radio transmitter, a third radio signal;
receiving, by a reference radio transceiver, the third radio signal; and
transmitting, by the reference radio transceiver, a fourth radio signal;
wherein estimating the extent of corrosion of the corrodible portion of the antenna assembly is also based on comparing the second radio signal to the fourth radio signal.

30. The method of claim 29 wherein the first radio signal and the third radio signal are the same signal.
